(19) United States
(12) Patent Application Publication
(10) Pub. No.: US 2019/0073622 A1
(43) Pub. Date: Mar. 7, 2019

(54) INFORMATION PROCESSING DEVICE AND INFORMATION PROCESSING METHOD

(71) Applicant: NEC Corporation, Minato-ku, Tokyo (JP)

(72) Inventor: Shinichiro YOSHIDA, Tokyo (JP)

(73) Assignee: NEC Corporation, Minato-ku, Tokyo (JP)

(21) Appl. No.: 16/083,570

(22) PCT Filed: Feb. 24, 2017
(86) PCT No.: PCT/JP2017/007155

§ 371 Date: Sep. 10, 2018

(30) Foreign Application Priority Data
Mar. 24, 2016 (JP) 2016-059618

(51) Int. Cl. G06Q 10/06

(52) U.S. Cl. CPC G06Q 10/063112; G06Q 10/063118; G06Q 10/0633

(57) ABSTRACT

An information processing device that supports management of an operation and workers on a managed object includes: an alarm generation unit that monitors the managed object and, when an operation on the managed object is required, generates information on the operation as alarm information; a worker information storage unit that stores information on the workers as worker information; a worker candidate extraction unit that extracts a candidate who performs the operation out of the workers based on the alarm information and the worker information; and a display unit that displays the alarm information on the operation and the worker information on the workers in association with each other.

### TECHNICAL FIELD

The present invention relates to an information processing device and an information processing method that support management of operations and workers for a managed object.

### BACKGROUND ART

In operation of a massive facility such as a plant or a data center, a responsibility is shared by managers in charge in a management center (central monitoring room) and workers in charge on site. A responsibility of a manager in charge in the management center is, for example, monitoring of a facility to be managed, support on site, or the like. On the other hand, a responsibility of a worker in charge on site is, for example, operation, maintenance inspection, or the like of a facility.

While few managers in charge need to manage the facility, there are a large number of workers in charge on site, and there are various attributes of respective workers in charge such as a skill or a working state. For this reason, a management system that has a function of reducing load of managers in charge is introduced. For example, Patent Literature 1 discloses a management system that monitors the facility and delivers information on the monitoring to a terminal device used by a manager in charge.

### CITATION LIST

Patent Literature

PTL 1: Japanese Patent Application Laid-Open No. 2002-133564

### SUMMARY OF INVENTION

### Technical Problem

In Patent Literature 1, the manager in charge in the management center needs to extract and assign site workers based on information delivered from the management system. Therefore, the accuracy of an assignment of site workers depends on each manager in charge, and thus there is a problem of reduction in objectivity and stability of the assignment. Further, it is inefficient that a busy manager in charge has to extract optimal site personnel for respective operations, and thus there is a problem of delay of an action.

### Solution to Problem

An information processing device according to the present invention is an information processing device that supports management of an operation and workers for a managed object, and the information processing device includes: an alarm generation unit that monitors the managed object and, when an operation on the managed object is required, generates information on the operation as alarm information; a worker information storage unit that stores information on the workers as worker information; a worker candidate extraction unit that extracts a candidate who performs the operation out of the workers based on the alarm information and the worker information; and a display unit that displays the alarm information on the operation and the worker information on the workers in association with each other.

An information processing method according to the present invention is an information processing method of supporting management of an operation and workers for a managed object, and the information processing method includes: at a management system, an alarm generating step of monitoring the managed object and, when an operation on the managed object is required, generating information on the operation as alarm information; a worker candidate extraction step of extracting a candidate that performs the operation out of the workers based on the alarm information and the worker information on the workers; and a displaying step of displaying the alarm information on the operation and the worker information on the workers in association with each other.

### Advantageous Effects of Invention

According to the present invention, an information processing device and an information processing method that can support objective and efficient assignment of a worker who works for a managed object can be obtained.

### BRIEF DESCRIPTION OF DRAWINGS

FIG. 1 is a schematic diagram illustrating a configuration of a management system according to a first example embodiment in addition to a configuration of a terminal device on site.

FIG. 2 is a diagram illustrating an example of alarm information stored in an alarm storage unit in the management system according to the first example embodiment.

FIG. 3 is a diagram illustrating an example of worker information stored in a worker information storage unit in the management system according to the first example embodiment.

FIG. 4 is a flowchart illustrating an information processing method in the management system and the terminal device according to the first example embodiment.

FIG. 5 is a diagram illustrating an example of a window that displays alarm information in the management system according to the first example embodiment.

FIG. 6 is a diagram illustrating an example of a worker candidate confirmation window in the management system according to the first example embodiment.

FIG. 7 is a diagram illustrating an example of an inquiry confirmation window in the terminal device according to the first example embodiment.

FIG. 8 is a diagram illustrating an example of an acceptance confirmation window in the management system according to the first example embodiment.

FIG. 9 is a diagram illustrating an example of an operation request confirmation window in the terminal device according to the first example embodiment.

FIG. 10 is a diagram illustrating an example of an inquiry cancellation window in the terminal device according to the first example embodiment.

FIG. 11 is a diagram illustrating an example of an operation report fill-in window in the terminal device according to the first example embodiment.

FIG. 12 is a diagram illustrating an example of an operation report review window in the management system according to the first example embodiment.

FIG. 13 is a flowchart illustrating a worker candidate extraction process in the management system according to the first example embodiment.

### DESCRIPTION OF EMBODIMENTS

The example embodiments of the present invention will be described below by using the drawings. Note that the present invention is not limited to the following example embodiment, and appropriate modification is possible without departing from the scope thereof. Further, in the drawings described below, components having the same function are labeled with the same reference, and the description thereof may be omitted or simplified.

### First Example Embodiment

In a massive facility such as a plant or a data center (hereafter, referred to as a “managed object”), a management system for reducing the load of a manager in charge in a management center (hereafter, referred to as a “center”) is introduced as described above. The following functions are mainly required for such a management system.

(1) Management function: managing information on a plurality of operations proceeding at the same time on the managed object or information on a plurality of workers in charge on site that has various attributes such as a skill and a working status (hereafter, referred to as a “worker”) in a centralized manner with consistency.

(2) Analysis function: generating an alarm when an operation is required for the managed object in addition to monitoring the managed object. Further, extracting a candidate for performing an operation out of workers based on information on an operation and workers.

(3) Display function: displaying information on operations and workers in an optimal manner according to application, a display device, or the like. In the management center, for example, displaying a window of a perspective view of the entire managed object in a normal condition and a window that focuses on a part where an anomaly occurs in an abnormal condition. On the other hand, on site, displaying only information on the operation on a terminal device such as a mobile terminal used by a worker.

(4) Communication function: performing communication for an inquiry for acceptance of an operation or a response thereto between the center and workers.

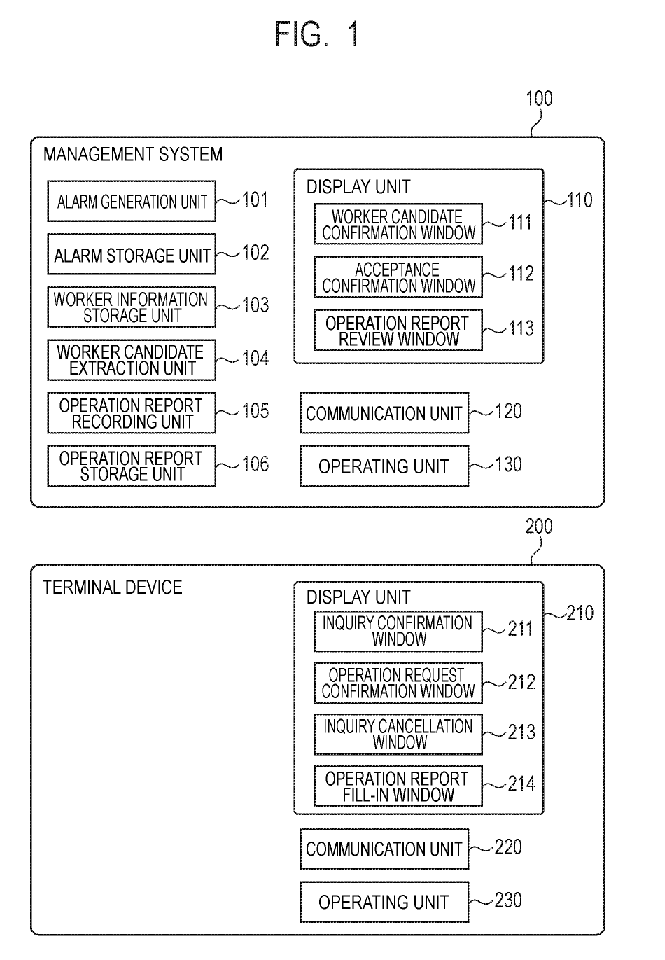

FIG. 1 is a schematic diagram illustrating a configuration of a management system 100 according to the first example embodiment in addition to a configuration of a terminal device 200. The management system 100 includes the functions (1) to (4) described above for reducing the load of the center. The terminal device 200 has a function of performing communication with the management system 100 and a function of displaying information on the operation and is used by a worker on site. Note that, in the present example embodiment, the terminal device 200 is not necessarily required to be provided, and the terminal device 200 can be omitted.

The management system 100 has an alarm generation unit 101, an alarm storage unit 102, a worker information storage unit 103, a worker candidate extraction unit 104, an operation report recording unit 105, an operation report storage unit 106, a display unit 110, a communication unit 120, and an operating unit 130. The display unit 110 has a function of displaying a worker candidate confirmation window 111, an acceptance confirmation window 112, and an operation report review window 113.

The terminal device 200 has a display unit 210, a communication unit 220, and an operating unit 230. The display unit 210 has a function of displaying an inquiry confirmation window 211, an operation request confirmation window 212, an inquiry cancellation window 213, and an operation report fill-in window 214.

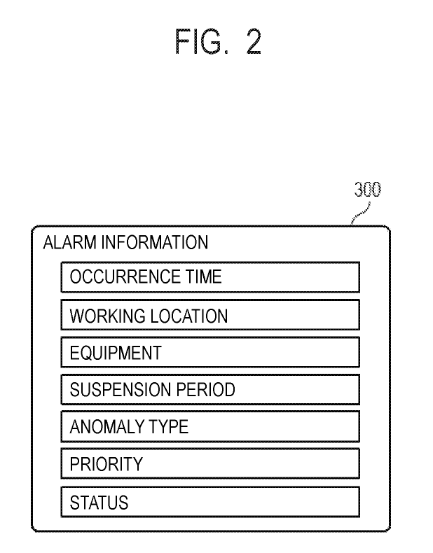

FIG. 2 is a diagram illustrating an example of alarm information 300 stored in the alarm storage unit 102 in the management system 100 according to the first example embodiment. The alarm information 300 is generated by the alarm generation unit 101 that is a calculation means including an analysis engine that can calculate a suspension period from a sign of an operation to an accident. The alarm information 300 illustrated in FIG. 2 includes information on “occurrence time”, “working location”, “equipment”, “suspension period”, “anomaly type”, “priority”, and “status (current operating status)” of an alarm.

The term “occurrence time” represents the time when the management system 100 generates the alarm information 300, however, it may be the time when an anomaly occurs in the managed object. The term “working location” represents a place of a managed object or a place where a worker performs an operation on the managed object. The term “equipment” represents equipment on which the worker performs the operation and is identified by a common name, a specific name, an identification number, or the like of the equipment, for example. The term “suspension period” represents a suspension period until the time when the worker is expected to start the operation. The term “anomaly type” represents a type of malfunction which is classified into fire, oil leakage, or the like in a plant, for example. Further, in a case of the data center, for example, it is classified into a power source malfunction, an air conditioning malfunction, or the like. The term “priority” represents the priority of an operation and may include, for example, information such as anomaly, an anomaly sign, a warning notice, or the like in addition to information such as classification of high, medium, low, or the like. The term “status” represents an alarm attribute related to an operation status such as “not started”, “completed”, or the like. Note that the alarm information 300 is not necessarily limited to the configuration described in FIG. 2.

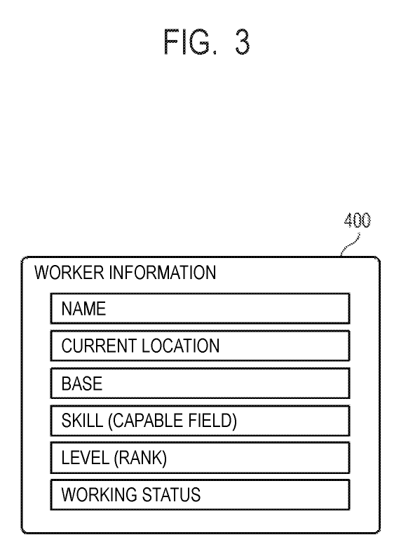

FIG. 3 is a diagram illustrating an example of worker information 400 stored in the worker information storage unit 103 in the management system 100 according to the first example embodiment. The worker information 400 illustrated in FIG. 3 includes information on “name”, “current location”, “base”, “skill (capable field)”, “level (rank)”, and “working status” of a worker. The worker information 400 is periodically updated by the worker information storage unit 103.

The terms “name”, “current location”, and “base” represent a name, a current location, and a base of a worker, respectively. The term “skill (capable field)” represents information on an operation skill owned by the worker and is identified according to the presence or absence of a skill capable of addressing the anomaly type in the alarm information 300, a grade of the skill, a proficiency level, or the like, for example. This skill information enables absolute determination on suitability (that is, determination on capability of addressing the operation) or relative determination on suitability (that is, determination of a preferable worker for the operation) on the operation for the anomaly type. The term “level (rank)” represents a level or a rank of the worker and may include information such as the presence or absence of the level of capability of addressing the priority of the alarm information 300, a beginner or an expert, or the like in addition to such as classification of high, medium, low, or the like, for example. Further, it may be linked with titles or the like. The term “working status” represents the current working status of a worker.

The alarm information 300 illustrated in FIG. 2 and the worker information 400 illustrated in FIG. 3 may include further lower-level concept information in a hierarchical manner. As an example, in a case of working status of the worker information 400, for example, first, it is further classified into “working” or “idle” which is a lower-level concept. Then “working” is classified into lower-lever concepts (a1) to (a2) below.

(a1) “in operation”: a state of performing the operation, and it is predicted that the worker is detained at the operation for at least a predetermined time period.

(a2) “operating for a while”: a state of performing the operation, but it is predicted that the operation will have been finished in a predetermined time.

Similarly, the term “idle” is classified into lower-level concepts (b1) to (b4) below.

(b1) “No operation”: a state where the next operation is not scheduled. Otherwise, while the next operation is scheduled, a worker is scheduled only for the operation that is less prioritized than a predetermined priority and thus is actually available.

(b2) “standby”: a state where the worker stands by and is not scheduled for the next operation for at least a predetermined time period.

(b3) “standby for a while”: a state where the worker stands by but is scheduled for the next work within a predetermined time period.

(b4) “unable to work”: a state where there is a special circumstance.

Note that the worker information 400 is not necessarily limited to the configuration described in FIG. 3.

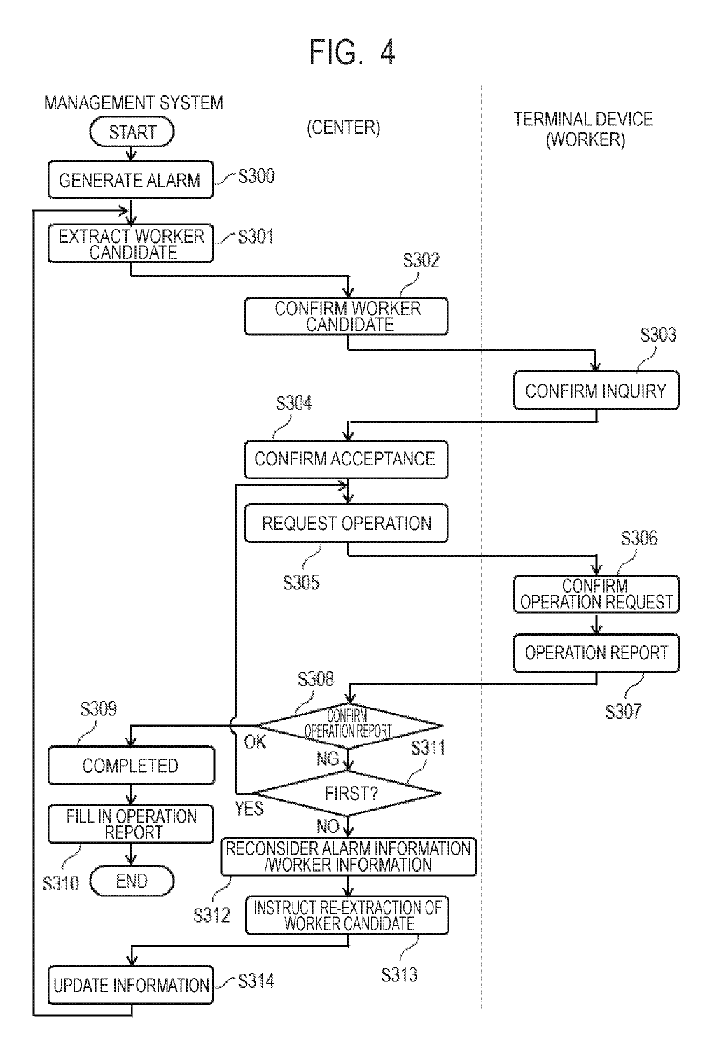

FIG. 4 is a flowchart illustrating an information processing method in the management system 100 and the terminal device 200 according to the first example embodiment. The process performed by the management system 100 and the terminal device 200 will be described below by using FIG. 4. At the “START” in FIG. 4, an analysis engine of the alarm generation unit 101 is monitoring the managed object. Further, the worker information storage unit 103 stores the worker information 400 on workers.

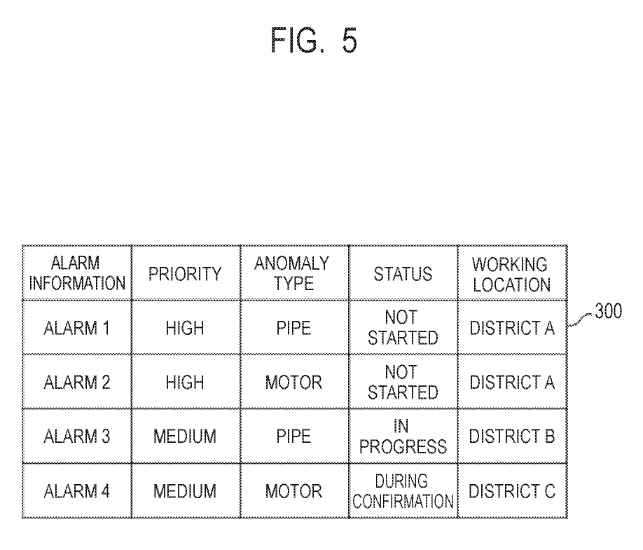

In step S300, when the analysis engine of the alarm generation unit 101 detects a sign of an operation, the alarm generation unit 101 generates information on the operation as the alarm information 300. The generated alarm information 300 is stored in the alarm storage unit 102 and displayed on the display unit 110 of the management system 100. FIG. 5 is a diagram illustrating an example of a window that displays the alarm information 300 in the management system 100 according to the first example embodiment. In the window of the display unit 110 of the management system 100 illustrated in FIG. 5, four items of the alarm information 300 are displayed.

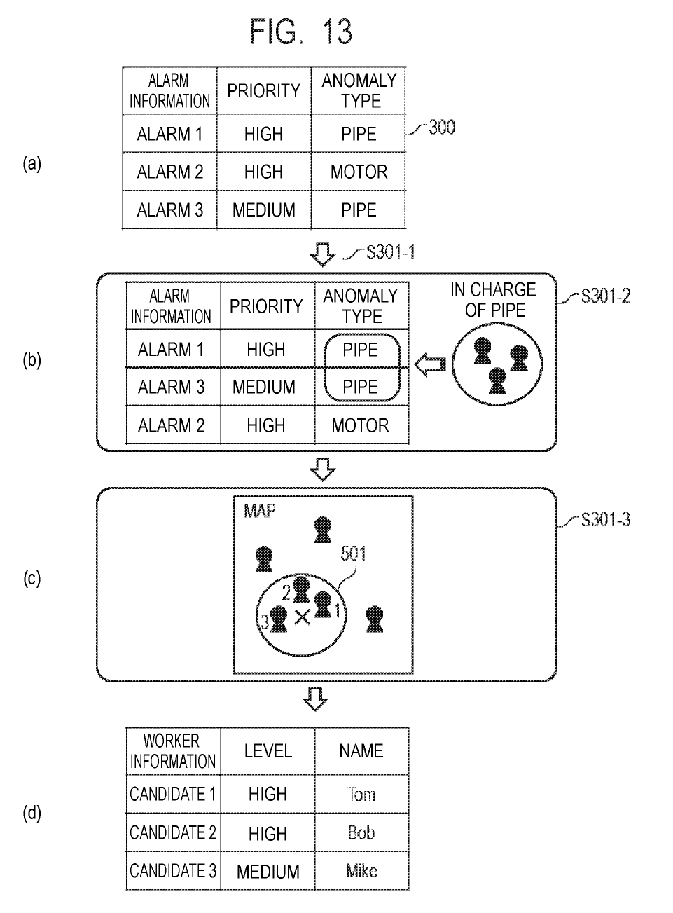

In step S301, the center selects one item from the alarm information 300 displayed on the display unit 110 of the management system 100 by using the operating unit 130 connected to a mouse, an operation button, a touch panel, or the like, for example. In response, the worker candidate extraction unit 104 extracts a candidate that performs the operation out of the workers registered in the worker information storage unit 103 based on the alarm information 300 and the worker information 400. A specific candidate extraction method by the worker candidate extraction unit 104 will be described later with reference to FIG. 13.

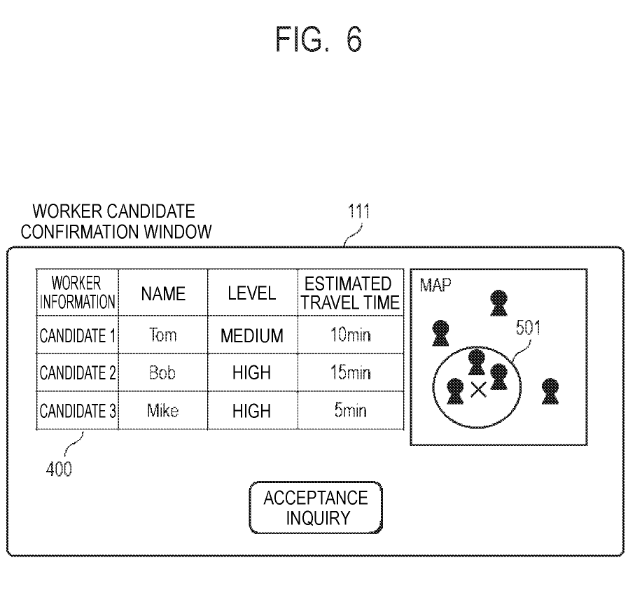

In step S302, a worker candidate is displayed in the worker candidate confirmation window 111 of the display unit 110. FIG. 6 is a diagram illustrating an example of the worker candidate confirmation window 111 in the management system 100 according to the first example embodiment. In the worker candidate confirmation window 111 illustrated in FIG. 6, the names and the level in the worker information 400 on three candidates who are extracted by the worker candidate extraction unit 104 are displayed. Further, the estimated travel time that is calculated from a working location of the alarm information 300 on the operation and the current locations of the worker information 400 on the worker candidates are displayed. Further, in the region on the right side in the worker information 400, a reachable area 501 that is calculated from the working location of the alarm information 300 on the operation and the suspension period is displayed in addition to information on the current locations of workers. In the worker candidate confirmation window 111, a part of alarm information 300 on an operation object may also be displayed together.

The reachable area 501 here represents an area in which the worker can arrive at the working location in the alarm information 300 within a suspension period in the alarm information 300. As the reachable area 501, for example, a circumference whose radius is a distance obtained by multiplying a typical walking speed by the suspension time period may be displayed. Alternatively, instead of the typical walking speed, a speed of a vehicle expected to be used by the worker may be used based on the working location of the alarm information 300 and the base or the current location in the worker information 400. Further, a plurality of reachable areas 501 that are calculated by using different speeds may be displayed in combination or in a switching manner.

As described above, the display unit 110 of the management system 100 displays the alarm information 300 on the operation and the worker information 400 on the worker in association with each other in the worker candidate confirmation window 111 illustrated in FIG. 6. Note that, in the present example embodiment, all the items of the alarm information 300 illustrated in FIG. 2 or all the items of the worker information 400 illustrated in FIG. 3 are not necessarily required to be displayed, and it may be sufficient that at least one item from the alarm information 300 and one item from the worker information 400 may be displayed in association with each other. For example, in the worker candidate confirmation window 111 illustrated in FIG. 6, the estimated travel time and the reachable area 501 indicated with information on the current location of the workers are displayed as the associated information.

Note that the working location in the alarm information 300 may be specified by coordinate information such as latitude/longitude or may be specified by a location name such as “xx plant”, “xx district”, or “xx street”, for example. The same applies to the reachable area 501.

The center confirms a worker candidate in the worker candidate confirmation window 111 illustrated in FIG. 6. Then, the “acceptance inquiry” button in the worker candidate confirmation window 111 is pressed. The operation on the button by the center is detected by the operating unit 130 of the management system 100. In response, the communication unit 120 of the management system 100 transmits an inquiry for acceptance of the operation to the terminal device 200 used by a candidate. Note that, in the worker candidate confirmation window 111, the center may be allowed to edit the candidates, or the acceptance inquiry may be transmitted automatically without confirmation of the candidate by the center.

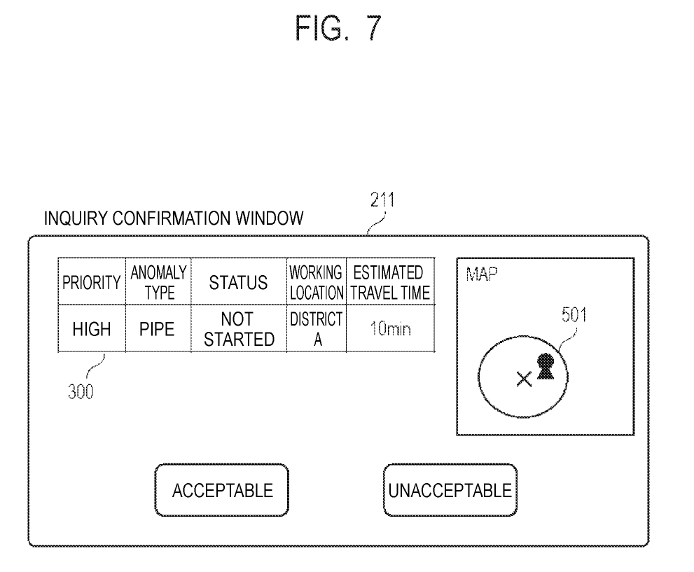

In step S303, the communication unit 220 of the terminal device 200 receives the acceptance inquiry from the management system 100. The acceptance inquiry received by the communication unit 220 is displayed in the inquiry confirmation window 211 in the display unit 210. FIG. 7 is a diagram illustrating an example of the inquiry confirmation window 211 on the terminal device 200 according to the first example embodiment. In FIG. 7, priority, anomaly type, status, and working location of the alarm information 300 on the requested operation are displayed. Further, the estimated travel time that is calculated by the working location of the alarm information 300 on the operation and the current location of the worker information 400 on the worker candidate is displayed. Further, in the region on the right side in the alarm information 300, the reachable area 501 calculated from the working location of the alarm information 300 on the operation and the suspension period is displayed in addition to information on the current location of the worker candidate. In the inquiry confirmation window 211, a part of the worker information 400 on the worker who uses the terminal device 200 may be displayed together, or a part of the worker information 400 on another worker to which the acceptance inquiry on the operation has been transmitted may be displayed together.

As described above, the display unit 210 of the terminal device 200 associates the alarm information 300 on the operation and the worker information 400 on the worker with each other and displays them in the inquiry confirmation window 211 illustrated in FIG. 7. Note that, in the present example embodiment, it is not necessary that all the items of the alarm information 300 illustrated in FIG. 2 or all the items of the worker information 400 illustrated in FIG. 3 are displayed, and it may be sufficient that at least one item of the alarm information 300 and one item of the worker information 400 are displayed in association with each other. In the inquiry confirmation window 211 illustrated in FIG. 7, for example, the estimated travel time and the reachable area 501 displayed with information on the current location of the worker are displayed as the associated information.

The worker candidate confirms the content of an acceptance inquiry on the operation in the inquiry confirmation window 211 illustrated in FIG. 7. The worker candidate then presses either the “acceptable” button or the “unacceptable” button in the inquiry confirmation window 211. The operation on the button performed by the worker is detected by the operating unit 230 connected to a mouse, an operation button, a touch panel, or the like, for example. In response, the communication unit 220 of the terminal device 200 transmits a response for acceptance of the operation to the management system 100. Note that, in the inquiry confirmation window 211, a response for acceptance by other worker candidates may be displayed.

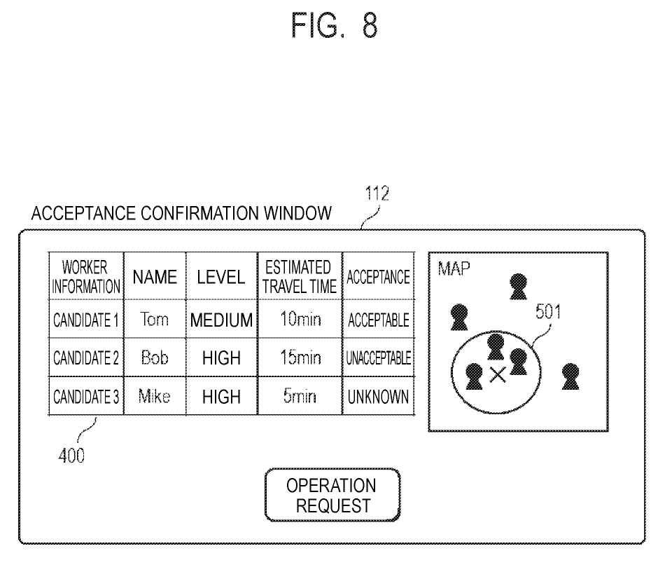

In step S304, the communication unit 120 of the management system 100 receives the response for acceptance from the terminal device 200 used by the worker candidate. The response for acceptance received by the communication unit 120 is displayed in the acceptance confirmation window 112 for the display unit 110. FIG. 8 is a diagram illustrating an example of the acceptance confirmation window 112 in the management system 100 according to the first example embodiment. In the acceptance confirmation window 112 illustrated in FIG. 8, information on the response for acceptance from the worker candidate is displayed in addition to information indicated in the worker candidate confirmation window 111 illustrated in FIG. 6. Since other displays are the same as the worker candidate confirmation window 111 illustrated in FIG. 6, the description thereof is omitted.

In step S305, the center confirms the acceptance of the worker in the acceptance confirmation window 112 illustrated in FIG. 8. The operating unit 130 is then used to select the worker who is assigned to the operation out of the available candidates and press the “operation request” button in the acceptance confirmation window 112. The communication unit 120 of the management system 100 then transmits an operation request to the terminal device 200 used by the worker to which the operation is requested. Note that, in the acceptance confirmation window 112, the available candidates may be displayed in the upper part of the list and selected automatically or may be selected by the center with a displayed check box or the like. Further, when the operation request is transmitted, the expiration date or the like calculated from the suspension period of the alarm information 300 may be notified together.

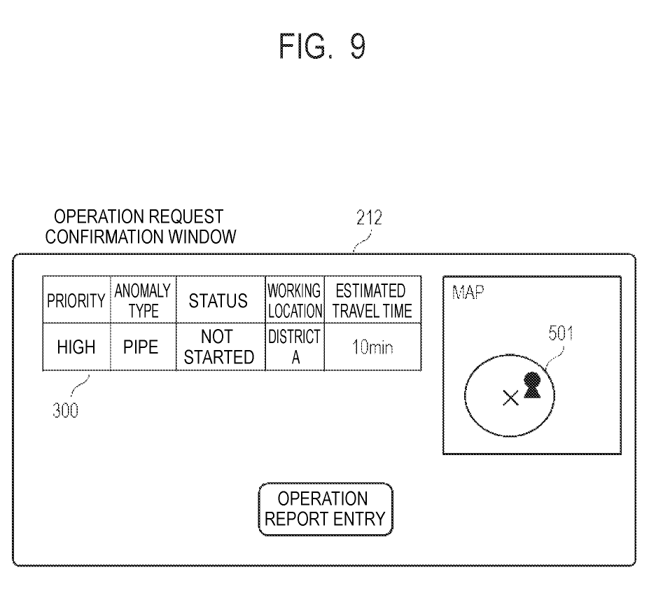

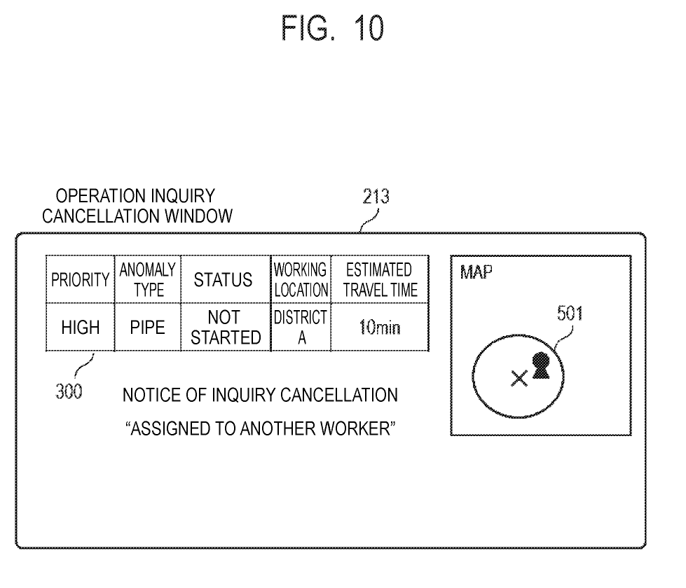

In step S306, the communication unit 220 of the terminal device 200 receives the operation request from the management system 100. The operation request received by the communication unit 220 is displayed in the operation request confirmation window 212 on the display unit 210. FIG. 9 is a diagram illustrating an example of the operation request confirmation window 212 in the terminal device 200 according to the first example embodiment. Since information displayed in the operation request confirmation window 212 illustrated in FIG. 9 is the same as the inquiry confirmation window 211 illustrated in FIG. 7, the description thereof is omitted. On the other hand, the inquiry cancellation window 213 is displayed on the terminal device 200 used by a worker candidate who has received the inquiry of availability but is not requested for the operation. FIG. 10 is a diagram illustrating an example of the inquiry cancellation window 213 in the terminal device 200 according to the first example embodiment.

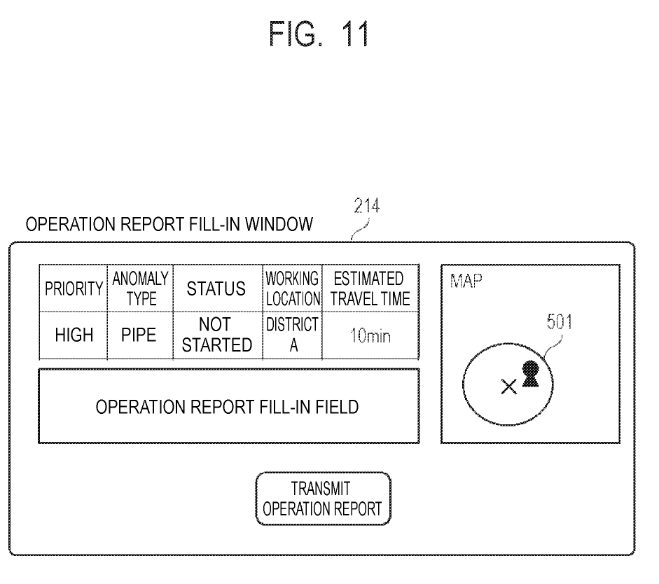

In step S307, the worker confirms the content of the operation in the operation request confirmation window 212 illustrated in FIG. 9 and performs the operation on site. Upon the completion of the operation, the worker presses the “operation report fill-in” button in the operation request confirmation window 212 by using the operating unit 230. In response, the display unit 210 of the terminal device 200 displays the operation report fill-in window 214. FIG. 11 is a diagram illustrating an example of the operation report fill-in window 214 in the terminal device 200 according to the first example embodiment. The worker fills in the operation report in an operation report fill-in field in the operation report fill-in window 214 illustrated in FIG. 11 by using the operating unit 230 and presses the “transmit operation report” button. In response, the communication unit 220 of the terminal device 200 transmits the content of the operation report filled in the operation report fill-in field to the management system 100.

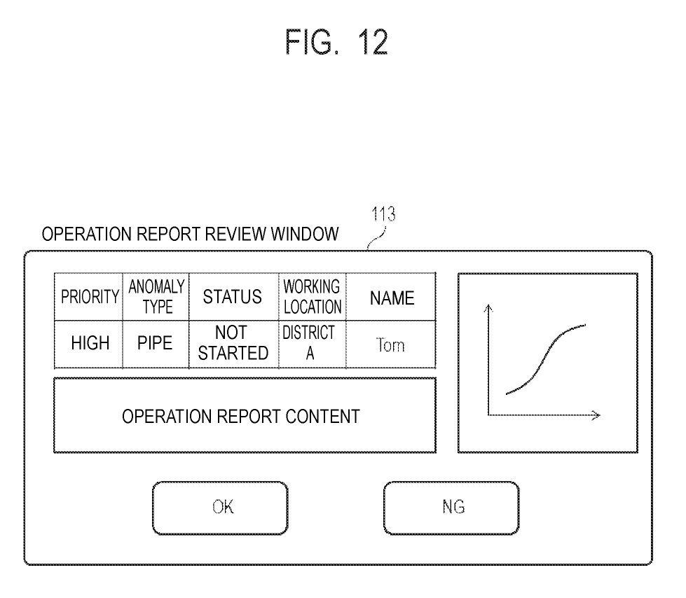

In step S308, the communication unit 120 of the management system 100 receives the operation report from the terminal device 200 used by the worker candidate. The operation report received by the communication unit 120 is displayed in the operation report review window 113 on the display unit 110. FIG. 12 is a diagram illustrating an example of the operation report review window 113 in the management system 100 according to the first example embodiment. In the operation report review window 113 illustrated in FIG. 12, the content of the operation report submitted by the worker who has performed the operation is displayed. In the operation report review window 113, an image such as a graph related to the alarm information 300 can be displayed. The center reviews the content of the operation report in the operation report review window 113, presses the “OK” button if the content of the operation report is acceptable, otherwise presses the “NG” button. The process proceeds to step S309 if the “OK” button is pressed, while the process proceeds to step S311 if the “NG” button is pressed.

In step S309, the operation report storage unit 105 of the management system 100 sets the status of the alarm information 300 on the operation determined by the center as “OK” to “completed” and records it in addition to the operation report in step S310. The recorded operation report is stored in the operation report storage unit 106.

In step S311, the management system 100 determines whether or not it is the first time that the content of the operation report on the operation is determined as “NG”. If it is the first “NG” (YES), the process returns to step S305 to perform the operation again. On the other hand, if it is the second or subsequent “NG” (NO), the process proceeds to step S312.

In step S312, the center reconsiders the alarm information 300 on the operation and the worker information 400 on the workers. For example, the center changes the anomaly type in the alarm information 300 or the levels in the worker information 400. In step S313, the center then instructs the management system 100 to re-extract a worker. In response, in step S314, the management system 100 updates the alarm information 300 and the worker information 400 edited by the center and returns to step S301 to repeat the process described above. Note that the process from step S312 to step S313 may be automatically performed by the management system 100.

As discussed above, a current location of a worker or a response for acceptance from a worker on the management system 100 is confirmed, which can eliminate inefficiency of the assigned worker on site being unable to address the operation within the suspension period. Further, when fees are decided in accordance with workload of the worker or the period to completion, further reduction in a unit price and further reduction in the required time are expected depending on competition principle.

Next, an example of a process of worker candidate extraction in the worker candidate extraction unit 104 will be described more specifically by using FIG. 13. FIG. 13 is a flowchart illustrating a worker candidate extraction process in the management system 100 according to the first example embodiment. The flowchart illustrated in FIG. 13 corresponds to the process of worker candidate extraction in step S301 of the flowchart of the information processing method illustrated in FIG. 4.

In step S301-1, the worker candidate extraction unit 104 classifies multiple pieces of the alarm information 300 on an anomaly type basis and sorts them in the order of priority. At this time, when the priority is the same, the worker candidate extraction unit 104 determines that the shorter the suspension time is, the higher the priority is. For example, the list of the alarm information illustrated in FIG. 13(a) is classified and sorted by the worker candidate extraction unit 104 as illustrated in FIG. 13(b).

In step S301-2, the worker candidate extraction unit 104 processes multiple pieces of the alarm information 300 on an anomaly type basis. In FIG. 13(b), for example, for the operation that the anomaly type is a type of “pipe”, a candidate is extracted out of the workers in charge of pipes who has a skill capable of handling pipes. Further, at this time, the worker candidate extraction unit 104 processes multiple pieces of alarm information having the same “pipe” anomaly type in descending order of priority. In FIG. 13(b), for example, alarm 1 and then alarm 3 are processed in this order.

In step S301-3, the worker candidate extraction unit 104 first calculates the reachable area 501 from the working location and the suspension period in the alarm information 300. Then, the worker candidate extraction unit 104 further extracts a candidate out of the workers whose current location is included in the reachable area 501 and whose working status is “idle”. At this time, as illustrated in FIG. 3, a worker may be extracted, in the order of the state (b1) to the state (b3), for example, with reference to information that is a further lower-level concept of the worker information 400. Alternatively, when there is no worker who is in a state of “idle”, a worker who is in a state of “working” and a state of (a2) may be extracted. If there is still no worker who satisfies the condition, a worker is extracted in ascending order of estimate travel time. In FIG. 13(c), for example, workers 1 to 3 located within the reachable area 501 are extracted. In FIG. 13(d), a list of the worker candidates extracted by the worker candidate extraction unit 104 is illustrated.

As described above, the worker candidate extraction unit 104 extracts the candidate who performs the operation based on the alarm information 300 and the worker information 400, and thereby the workers can be assigned objectively and stably without dependency on personal efforts. Note that the worker candidate extraction process according to the present example embodiment is not limited to the method illustrated in FIG. 13, and other methods can also be used.

As described above, the information processing device according to the present example embodiment has a worker candidate extraction unit that extracts a candidate who performs an operation from workers based on alarm information and worker information. Further, it displays the alarm information on an operation and the worker information on a worker in association with each other. Thus, the information processing device and the information processing method that can support an objective and efficient assignment of a worker who performs an operation for the managed object can be obtained.

### Other Example Embodiments

The present invention can be realized by a process in which a program that implements one or more functions of the example embodiment described above is provided to a system or a device via a network or a storage medium and one or more processors in a computer of the system or the device read and execute the program. Further, it can also be realized by using a circuit that implements one or more functions (for example, ASIC).

Further, each of the example embodiments described above merely illustrates an example of embodiment in implementing the present invention, and the technical scope of the present invention should not be construed in a limiting sense by these example embodiments. That is, the present invention can be embodied in various forms without departing from the technical concept or the primary features.

For example, a window displayed on the display unit 110 of the management system 100 may also be displayed on a terminal device used by a manager in charge in the management center. Further, when the management system 100 transmits information to the terminal device 200 of a worker, information on tools and instructions necessary for the operation may also be transmitted together. Further, while the management system 100 starts the process in response to generation of an alarm in the flowchart illustrated in FIG. 4, it may be started in response to an operation performed by the center. In this case, the condition that the management system 100 starts the process is set in advance by the center.

Further, in the first example embodiment, a facility such as a plant or a data center is assumed as “managed object”, however, the managed objects are not limited thereto. For example, the managed object may be a moving object such as a vehicle, an airplane, or the like. Also in these cases, when a vehicle, an airplane, or the like that is a managed object is at a parking area or a parking place or is not moving, the same scheme as that in the first example embodiment can be used for management in a similar manner to the case of a facility. On the other hand, when the managed object is moving, the alarm information 300 may be updated as the managed object moves, or the alarm information 300 may not be generated and the managed object may not be managed.

The whole or part of the example embodiments disclosed above can be described as, but not limited to, the following supplementary notes.

(Supplementary Note 1)

An information processing device that supports management of an operation and workers on a managed object, the information processing device comprising:

an alarm generation unit that monitors the managed object and, when an operation on the managed object is required, generates information on the operation as alarm information;

a worker information storage unit that stores information on the workers as worker information;

a worker candidate extraction unit that extracts a candidate who performs the operation out of the workers based on the alarm information and the worker information; and

a display unit that displays the alarm information on the operation and the worker information on the workers in association with each other.

(Supplementary Note 2)

The information processing device according to supplementary note 1,

wherein the worker information includes information on a working status of the workers; and

wherein the worker candidate extraction unit prioritizes the workers whose working status is idle to extract the worker candidate.

(Supplementary note 3)

The information processing device according to supplementary note 1 or 2,

wherein the alarm information includes information on a working location and a suspension period of the operation,

wherein the worker information includes information on a current location of the workers,

wherein the worker candidate extraction unit calculates a reachable area based on the working location and the suspension period and prioritizes the workers whose current locations are included in the reachable area to extract the worker candidate, and

wherein the display unit displays information on the reachable area in addition to information on the current location of the workers.

(Supplementary Note 4)

The information processing device according to any one of supplementary notes 1 to 3,

wherein the alarm information includes information on an anomaly type of the operation,

wherein the worker information includes skill information on the workers,

wherein the worker candidate extraction unit prioritizes the workers having the skill suitable for the anomaly type to extract the worker candidate, and

wherein the display unit classifies and displays the alarm information on the operation on the anomaly type basis.

(Supplementary Note 5)

The information processing device according to any one of supplementary notes 1 to 4,

wherein the alarm information includes information on a priority of the operation,

wherein the worker information includes information on a level of the workers,

wherein the worker candidate extraction unit prioritizes the workers whose level is low out of the workers whose level satisfies the priority to extract the worker candidate, and

wherein the display unit displays the alarm information on the operation in descending order of the priority.

(Supplementary note 6)

An information processing method of supporting management of an operation and workers on a managed object, the information processing method comprising:

at a management system,

an alarm generating step of monitoring the managed object and, when an operation on the managed object is required, generating information on the operation as alarm information;

a worker candidate extraction step of extracting a candidate that performs the operation out of the workers based on the alarm information and worker information on the workers; and

a displaying step of displaying the alarm information on the operation and the worker information on the workers in association with each other.

(Supplementary Note 7)

The information processing method according to supplementary note 6 further comprising steps of:

at the management system,

transmitting, to a terminal device used by the worker candidate, an acceptance inquiry of the operation to the worker candidate;

receiving, from the terminal device, a response for the acceptance from the worker candidate; and

displaying the response for the acceptance on a display unit of the management system in addition to the worker information on the worker candidate.

(Supplementary Note 8)

The information processing method according to supplementary note 6 or 7 further comprising steps of:

at the management system, transmitting, to a terminal device used by the workers, a request for the operation to the workers;

receiving, from the terminal device, an operation report on the operation performed by the workers; and

displaying the operation report on the display unit of the management system in addition to the worker information on the workers.

(Supplementary Note 9)

The information processing method according to supplementary note 7 further comprising steps of:

at the terminal device,

receiving the acceptance inquiry from the management system;

displaying the acceptance inquiry on the display unit of the terminal device in addition to the alarm information on the operation; and

transmitting a response for the acceptance from the worker candidate to the management system.

(Supplementary Note 10)

The information processing method according to supplementary note 8 further comprising steps of:

at the terminal device, receiving the operation request from the management system;

displaying the operation request on a display unit of the terminal device in addition to the alarm information on the operation; and

transmitting the operation report on the operation performed by the workers to the management system.

Although the present invention has been described with reference to the example embodiments, the present invention is not limited to the example embodiments described above. Various modifications that can be understood by those skilled in the art within the scope of the present invention can be made to the configuration and the details of the present invention.

This application is based upon and claims the benefit of priority from Japanese Patent Application No. 2016-059618, filed on Mar. 24, 2016, the disclosure of which is incorporated herein in its entirety by reference.

What is claimed is:

1. An information processing device that supports management of an operation and workers on a managed object, the information processing device comprising:
an alarm generation unit that monitors the managed object and, when an operation on the managed object is required, generates information on the operation as alarm information;
a worker information storage unit that stores information on the workers as worker information;
a worker candidate extraction unit that extracts a candidate who performs the operation out of the workers based on the alarm information and the worker information; and
a display unit that displays the alarm information on the operation and the worker information on the workers in association with each other.

2. The information processing device according to claim 1,
wherein the worker information includes information on a working status of the workers; and
wherein the worker candidate extraction unit prioritizes the workers whose working status is idle to extract the worker candidate.

3. The information processing device according to claim 1,
wherein the alarm information includes information on a working location and a suspension period of the operation,
wherein the worker information includes information on a current location of the workers,
wherein the worker candidate extraction unit calculates a reachable area based on the working location and the suspension period and prioritizes the workers whose current locations are included in the reachable area to extract the worker candidate, and
wherein the display unit displays information on the reachable area in addition to information on the current location of the workers.

4. The information processing device according to claim 1,
wherein the alarm information includes information on an anomaly type of the operation,
wherein the worker information includes skill information on the workers,
wherein the worker candidate extraction unit prioritizes the workers having the skill suitable for the anomaly type to extract the worker candidate, and
wherein the display unit classifies and displays the alarm information on the operation on the anomaly type basis.

5. The information processing device according to claim 1,
wherein the alarm information includes information on a priority of the operation,
wherein the worker information includes information on a level of the workers,
wherein the worker candidate extraction unit prioritizes the workers whose level is low out of the workers whose level satisfies the priority to extract the worker candidate, and
wherein the display unit displays the alarm information on the operation in descending order of the priority.

6. An information processing method of supporting management of an operation and workers on a managed object, the information processing method comprising:
at a management system,
an alarm generating step of monitoring the managed object and, when an operation on the managed object is required, generating information on the operation as alarm information;
a worker candidate extraction step of extracting a candidate that performs the operation out of the workers based on the alarm information and worker information on the workers; and
a displaying step of displaying the alarm information on the operation and the worker information on the workers in association with each other.

7. The information processing method according to claim 6 further comprising steps of:
at the management system,
transmitting, to a terminal device used by the worker candidate, an acceptance inquiry of the operation to the worker candidate;
receiving, from the terminal device, a response for the acceptance from the worker candidate; and
displaying the response for the acceptance on a display unit of the management system in addition to the worker information on the worker candidate.

8. The information processing method according to claim 6 further comprising steps of:
at the management system,
transmitting, to a terminal device used by the workers, a request for the operation to the workers;
receiving, from the terminal device, an operation report on the operation performed by the workers; and
displaying the operation report on the display unit of the management system in addition to the worker information on the workers.

9. The information processing method according to claim 7 further comprising steps of:
at the terminal device,
receiving the acceptance inquiry from the management system;
displaying the acceptance inquiry on the display unit of the terminal device in addition to the alarm information on the operation; and
transmitting a response for the acceptance from the worker candidate to the management system.

10. The information processing method according to claim 8 further comprising steps of:
at the terminal device,
receiving the operation request from the management system;
displaying the operation request on a display unit of the terminal device in addition to the alarm information on the operation; and
transmitting the operation report on the operation performed by the workers to the management system.
